(19) United States
(12) Patent Application Publication
(10) Pub. No.: US 2026/0289935 A1
(43) Pub. Date: Sep. 24, 2026

(54) PROJECTOR WITH OLED

(71) Applicant: TRINAMIX GMBH, Ludwigshafen am Rhein (DE)

(72) Inventors: Patrick SCHINDLER, Ludwigshafen am Rhein (DE); Nils BERNER, Ludwigshafen am Rhein (DE); Jan David Alexander KOLOCZEK, Ludwigshafen am Rhein (DE)

(21) Appl. No.: 19/475,457

(22) PCT Filed: May 10, 2024
(86) PCT No.: PCT/EP2024/062902

§ 371 Date: Oct. 15, 2025

(30) Foreign Application Priority Data
May 11, 2023 (EP) 23172914.6

(51) Int. Cl. G06V 10/141; G06V 10/145; G06V 40/16; G06V 40/40; G09G 3/3208

(52) U.S. Cl. CPC G06V 10/141; G06V 10/145; G06V 40/172; G06V 40/40; G09G 3/3208; G09G 2354/00

(57) ABSTRACT

Disclosed herein is a method for authenticating a user of a device. The method includes:
a. projecting a plurality of light beams through a display onto the user by a projector, where the plurality of light beams includes a first light beam and a second light beam, and directing the first light beam and the second light beam to illuminate an at least partially overlapping area of the user by the display,
b. generating a pattern image showing the projecting of the plurality of light beams onto the user,
c. extracting liveness data from the pattern image,
d. allowing the user to perform an operation on the device that requires authentication based on the liveness data.

### TECHNICAL FIELD

The invention relates to a method for authenticating a user of a device and a device for authenticating a user. The present invention further relates to a computer program, a computer-readable storage medium and a non-transient computer-readable medium. The devices, methods and uses according to the present invention specifically may be employed for example in various areas of daily life, security technology, gaming, traffic technology, production technology, photography such as digital photography or video photography for arts, documentation or technical purposes, safety technology, information technology, agriculture, crop protection, maintenance, cosmetics, medical technology or in the sciences. However, other applications are also possible.

### BACKGROUND ART

Available authentication systems in mobile devices such as in smartphones, tablets and the like, include cameras. Said mobile devices usually have a front display such as an organic light-emitting diode (OLED) area and/or a quantum-dot light emitting diode (QLED) area. The camera may be positioned behind said front display. Moreover, in such devices for authentication a light projector is used, such as one or more light emitting diodes and/or laser, may be positioned behind the display. Usually, the light projector projects a pattern such as a point pattern onto a target, e.g. a face, the camera captures an image of the projection onto the user and material information is determined by a processor. If the material is classified as skin, it is identified as human and, otherwise, as a spoof target. The pattern generated by the light projector can be designed for a 3D algorithm, i.e. the pattern may be designed to allow easily solving the so-called correspondence problem. For smartphone application, a resulting 3D depth map can be used for further face authentication.

However, if the projector and camera are placed behind the display such as an OLED display the performance of the of the authentication system decreases. Even transparent OLEDs have a low transmission and can distort an optical image by strong diffractions. In this way, a light beam from the projector can be split into several light beams. The light beam can lose its power due to said diffraction resulting in significantly reduced power for the light beam to be projected onto the user. For example, under certain circumstances, with 80% diffraction loss and 10% OLED transmission, only 2% per light beam would remain. This loss of performance may be compensated with increased projector power. However, this is unfavorable due to battery performance of the smartphone. In addition, rays from the side orders of diffraction can be unfavorably distributed into the scene. Thus, spots to be projected become even more difficult to find.

### Problem to be Solved

It is therefore an object of the present invention to provide devices and methods facing the abovementioned technical challenges of known devices and methods. Specifically, it is an object of the present invention to provide devices and methods, which allow increasing a signal-to-noise ratio in a pattern image and thus, allow for accurate and reliable secure authentication even behind OLED with low transmissions.

### SUMMARY

This problem is addressed by a method for authenticating a user of a device and a device for authenticating a user with the features of the independent claims. Advantageous embodiments which might be realized in an isolated fashion or in any arbitrary combinations are listed in the dependent claims as well as throughout the specification.

In a first aspect of the present invention, a method for authenticating a user of a device is disclosed. The method comprises the following steps:
a. projecting a plurality of light beams through a display, in particular the display of the device, onto the user by a projector, wherein the plurality of light beams comprises a first light beam and a second light beam, and directing the first light beam and the second light beam to illuminate an at least partially overlapping area of the user by the display,
b. generating a pattern image showing the projecting of the plurality of light beams onto the user,
C. extracting liveness data from the pattern image,
d. allowing the user to perform an operation on the device that requires authentication based on the liveness data.

The method steps may be performed in the given order or may be performed in a different order. Further, one or more additional method steps may be present which are not listed. Further, one, more than one or even all of the method steps may be performed repeatedly.

The method may be computer-implemented. The term “computer implemented” as used herein is a broad term and is to be given its ordinary and customary meaning to a person of ordinary skill in the art and is not to be limited to a special or customized meaning. The term specifically may refer, without limitation, to a method involving at least one computer and/or at least one computer network. The computer and/or computer network may comprise at least one processor which is con-figured for performing at least one of the method steps of the method according to the present invention. Specifically, each of the method steps is performed by the computer and/or computer network. The method may be performed completely automatically, specifically without user interaction.

The device may be selected from the group consisting of: a television device; a game console; a personal computer; a mobile device, particularly a cell phone, and/or a smart phone, and/or, and/or a tablet computer, and/or a laptop, and/or a tablet, and/or a virtual reality device, and/or a wearable, such as a smart watch; or another type of portable computer.

The term “user” as used herein is a broad term and is to be given its ordinary and customary meaning to a person of ordinary skill in the art and is not to be limited to a special or customized meaning. The term specifically may refer, without limitation, to a person intended to and/or using the device.

The term “authenticating” as used herein is a broad term and is to be given its ordinary and customary meaning to a person of ordinary skill in the art and is not to be limited to a special or customized meaning. The term specifically may refer, without limitation, to verifying an identity of a user. Specifically, the authentication may comprise distinguishing between the user from other humans or objects, in particular between an authorized access from a non-authorized access. The authentication may comprise verifying identity of a respective user and/or assigning identity to a user. The authentication may comprise generating and/or providing identity information, e.g. to other devices or units such as to at least one authorization unit for authorization for providing access to the device. The identify information may be proofed by the authentication. For example, the identity information may be and/or may comprise at least one identity token. In case of successful authentication an image of a face recorded by at least one image generation unit may be verified to be an image of the user's face and/or the identity of the user is verified. The authenticating may be performed using at least one authentication process. The authentication process may comprise a plurality of steps such as at least one face detection, e.g. on at least one flood image as will be described in more detail below, and at least one identification step in which an identity is assigned to the detected face and/or at least one identity check and/or verifying an identity of the user is performed.

The term “light” as used herein is a broad term and is to be given its ordinary and customary meaning to a person of ordinary skill in the art and is not to be limited to a special or customized meaning. The term specifically may refer, without limitation, to electromagnetic radiation in one or more of the infrared, the visible and the ultraviolet spectral range. Herein, the term “ultraviolet spectral range”, generally, refers to electromagnetic radiation having a wavelength of 1 nm to 380 nm, preferably of 100 nm to 380 nm. Further, in partial accordance with standard ISO-21348 in a valid version at the date of this document, the term “visible spectral range”, generally, refers to a spectral range of 380 nm to 760 nm. The term “infrared spectral range” (IR) generally refers to electromagnetic radiation of 760 nm to 1000 μm, wherein the range of 760 nm to 1.5 μm is usually denominated as “near infrared spectral range” (NIR) while the range from 1.5μ to 15 μm is denoted as “mid infrared spectral range” (MidIR) and the range from 15 μm to 1000 μm as “far infrared spectral range” (FIR). Preferably, light used for the typical purposes of the present invention is light in the infrared (IR) spectral range, more preferred, in the near infrared (NIR) and/or the mid infrared spectral range (MidIR). Specifically, the projector projects at least one infrared light pattern, wherein the projected light beams have a wavelength in the infrared spectral range, preferably from 800 nm to 1300 nm, more preferably from 900 nm to 1000 nm, most preferably from 1100 nm to 1200 nm.

The term “projecting”, as used herein, is a broad term and is to be given its ordinary and customary meaning to a person of ordinary skill in the art and is not to be limited to a special or customized meaning. The term specifically may refer, without limitation, to the process of providing at least one light beam, in particular a light pattern onto at least one surface. The term “projector”, as used herein, is a broad term and is to be given its ordinary and customary meaning to a person of ordinary skill in the art and is not to be limited to a special or customized meaning. The term specifically may refer, without limitation, to an optical device configured for projecting at least one light beam onto a surface. The projector may be configured for generating and/or for providing at least one light pattern, in particular at least one infrared light pattern.

The term “light pattern” as used herein is a broad term and is to be given its ordinary and customary meaning to a person of ordinary skill in the art and is not to be limited to a special or customized meaning. The term specifically may refer, without limitation, to at least one arbitrary pattern comprising a plurality of light spots. The light spot may be at least partially spatially extended. At least one spot or any spot may have an arbitrary shape. In some cases a circular shape of at least one spot or any spot may be preferred. The spots may be arranged by considering a structure of the display. Typically, an arrangement of an OLED-pixel-structure of the display may be considered.

The light pattern may be an infrared light pattern. The term “infrared light pattern” as used herein is a broad term and is to be given its ordinary and customary meaning to a person of ordinary skill in the art and is not to be limited to a special or customized meaning. The term specifically may refer, without limitation, to a light pattern comprising spots in the infrared spectral range. The infrared light pattern may be a near infrared light pattern.

The light projected by the projector may be coherent. The light pattern may be a coherent, in particular infrared, light pattern. The projector may be configured for emitting light at a single wavelength, e.g. in the near infrared region. In other embodiments, the projector may be adapted to emit light with a plurality of wavelengths, e.g. for allowing additional measurements in other wavelengths channels.

The light pattern may comprise at least one regular and/or constant and/or periodic pattern such as a triangular pattern, a rectangular pattern, a hexagonal pattern or a pattern comprising further convex tilings. For example, the light pattern is a hexagonal pattern, preferably a hexagonal light pattern, preferably a ⅖ hexagonal infrared light pattern. Using a periodical ⅖ hexagonal pattern can allow distinguishing between artefacts and usable signal.

The light pattern may comprise at least one point pattern. The light pattern has a low point density. For example, a number of light beams projected on the user is lower than 5000, preferably lower than 3000, more preferably lower than 2000, even more preferably below 1500, most preferably below 1000. The light pattern may have a low point density, in particular in comparison with other structured light techniques having typically a point density of 10 k-30 k in a field of view of 55×38°. Using such a low point density may allow compensating for the above-mentioned diffraction loss. By decreasing the number of spots projected onto an object and/or a user, a contrast in the pattern image may be increased. Increasing the number of points would decrease the irradiance per point. The decreased number of spots may lead to an increase in irradiance of a spot and thus, to an increase in contrast in the pattern image of the projection of the infrared light pattern. The light pattern may have a periodic point pattern with a reduced number of spots, wherein each of the spots has a high irradiance. Such a light pattern can ensure improved authentication using illumination sources and image generation unit behind a display. Moreover, the low number of spots can ensure complying with eye safety requirements and stability requirements. The allowed dose may be divided between the spots of the light pattern.

At least one of the light spots may be associated with a beam divergence of 0.2° to 0.5°, preferably 0.1° to 0.3°. The term “beam divergence” as used herein is a broad term and is to be given its ordinary and customary meaning to a person of ordinary skill in the art and is not to be limited to a special or customized meaning. The term specifically may refer, without limitation, to at least one measure of an increase in at least one diameter and/or at least one diameter equivalent, such as a radius, with a distance from an optical aperture from which the beam emerges. The measure may be an angle or an angle equivalent. In the context of the present invention, typically, a beam divergence may be determined at 1/e².

The projector may comprise at least one least one emitter, in particular a plurality of emitters. The term “emitter” as used herein is a broad term and is to be given its ordinary and customary meaning to a person of ordinary skill in the art and is not to be limited to a special or customized meaning. The term specifically may refer, without limitation, to at least one arbitrary device configured for providing at least one light beam. The emitter may be selected from the group consisting of: at least one laser source such as at least one semi-conductor laser, at least one double heterostructure laser, at least one external cavity laser, at least one separate confinement heterostructure laser, at least one quantum cascade laser, at least one distributed Bragg reflector laser, at least one polariton laser, at least one hybrid silicon laser, at least one extended cavity diode laser, at least one quantum dot laser, at least one volume Bragg grating laser, at least one Indium Arsenide laser, at least one Gallium Arsenide laser, at least one transistor laser, at least one diode pumped laser, at least one distributed feedback lasers, at least one quantum well laser, at least one interband cascade laser, at least one semiconductor ring laser, at least one vertical cavity surface emitting laser (VCSEL); at least one non-laser light source such as at least one LED or at least one light bulb; at least one edge-emitting laser.

For example, the projector comprises at least one VCSEL, preferably a plurality of VCSELs. The plurality of VCSELs may be arranged in at least one array, e.g. comprising a matrix of VCSELs. The VCSELs may be arranged on the same substrate, or on different substrates. The term “vertical-cavity surface-emitting laser” as used herein is a broad term and is to be given its ordinary and customary meaning to a person of ordinary skill in the art and is not to be limited to a special or customized meaning. The term specifically may refer, without limitation, to a semiconductor laser diode configured for laser beam emission perpendicular with respect to a top surface. Examples for VCSELs can be found e.g. in en.wikipedia.org/wiki/Verticalcavity_surface-emitting_laser. VCSELs are generally known to the skilled person such as from WO 2017/222618 A. Each of the VCSELs is configured for generating at least one light beam. The VCSEL or the plurality of VCSELs may be configured for generating the desired spot number. The VCSELs may be configured for emitting light beams at a wavelength range from 800 to 1000 nm. For example, the VCSELs may be configured for emitting light beams at 808 nm, 850 nm, 940 nm, and/or 980 nm. Preferably the VCSELs emit light at 940 nm, since terrestrial sun radiation has a local minimum in irradiance at this wavelength, e.g. as described in CIE 085-1989 “Solar spectral Irradiance”.

The display may be configured for modifying the spots, e.g. by increasing a number of spots, generated by the projector when traversing the display. For example, the display may act as diffractive optical element (DOE). Thus, resources can be saved since the display functions as DOE and such that no further DOE is necessary. Moreover, less emitter, e.g. VCSEL cavities, are necessary since the light beams can be multiplicated by the display. Additionally or alternatively, the projector may comprise at least one optical element, e.g. configured for modifying the spots, e.g. by increasing a number of spots, selected from the group consisting of: at least one lens; at least one Micro-lens-array (MLA); at least one diffractive optical element (DOE); and at least one meta surface element. The DOE and/or the metasurface element may be configured for generating multiple light beams from a single incoming light beam. For example, a VCSEL projecting up to 2000 spots and an optical element comprising a plurality of metasurface elements may be used to duplicate the number of spots. Further arrangements, particularly comprising a different number of projecting VCSEL and/or at least one different optical element configured for increasing the number of spots may be possible. Other multiplication factors are possible. For example, a VCSEL or a plurality of VCSELs may be used and the generated laser spots may be duplicated by using at least one DOE.

The projector comprise at least one transfer device. The term “transfer device”, also denoted as “transfer system”, as used herein is a broad term and is to be given its ordinary and customary meaning to a person of ordinary skill in the art and is not to be limited to a special or customized meaning. The term specifically may refer, without limitation, to one or more optical elements which are adapted to modify the light beam, particularly the light beam used for generating at least a portion of the infrared light pattern, such as by modifying one or more of a beam parameter of the light beam, a width of the light beam or a direction of the light beam. The transfer device may comprise at least one imaging optical device. The transfer device specifically may comprise one or more of: at least one lens, for example at least one lens selected from the group consisting of at least one focus-tunable lens, at least one aspheric lens, at least one spherical lens, at least one Fresnel lens; at least one diffractive optical element; at least one concave mirror; at least one beam deflection element, preferably at least one mirror; at least one beam splitting element, preferably at least one of a beam splitting cube or a beam splitting mirror; at least one multi-lens system; at least one holographic optical element; at least one meta optical element. Specifically, the transfer device comprises at least one refractive optical lens stack. The transfer device may comprise a multi-lens system having refractive properties.

The method further may comprise emitting flood light by at least one flood illumination source and generating at least one flood image while the flood illumination source is emitting flood light. The term “flood illumination source” as used herein is a broad term and is to be given its ordinary and customary meaning to a person of ordinary skill in the art and is not to be limited to a special or customized meaning. The term specifically may refer, without limitation, to at least one arbitrary device configured for providing substantially continuous spatial illumination. The term “flood light” as used herein, is a broad term and is to be given its ordinary and customary meaning to a person of ordinary skill in the art and is not to be limited to a special or customized meaning. The term specifically may refer, without limitation, to substantially continuous spatial illumination, in particular diffuse and/or uniform illumination. The flood light has a wavelength in the infrared range, in particular in the near infrared range. The flood illumination source may comprise at least one LED or at least one VCSEL, preferably a plurality of VCSELs. The plurality of VCSELs may overlap to a uniform area. The term “substantially continuous spatial illumination” as used herein is a broad term and is to be given its ordinary and customary meaning to a person of ordinary skill in the art and is not to be limited to a special or customized meaning. The term specifically may refer, without limitation, to uniform spatial illumination, wherein areas of non-uniform are possible. The area, e.g. covering a user, a portion of the user and/or a face of the user, illuminated from the flood illumination source, may be contiguous. Power may be spread over a whole field of illumination. In contrast, illumination provided by the light pattern may comprise at least two contiguous areas, in particular a plurality of contiguous areas, and/or power may be concentrated in small (compared to the whole field of illumination) areas of the field of illumination. The infrared flood illumination may be suitable for illuminating a contiguous area, in particular one contiguous area. The infrared pattern illumination may be suitable for illuminating at least two contiguous areas.

The flood illumination source may illuminate a measurement area, such as a user, a portion of the user and/or a face of the user, with a substantially constant illumination intensity. The term “constant” as used herein, is a broad term and is to be given its ordinary and customary meaning to a person of ordinary skill in the art and is not to be limited to a special or customized meaning. The term specifically may refer, without limitation, to a time aspect during an exposure time. Flood light may vary temporally and/or may be substantially constant over time. The term “substantially constant” as used herein, is a broad term and is to be given its ordinary and customary meaning to a person of ordinary skill in the art and is not to be limited to a special or customized meaning. The term specifically may refer, without limitation, to a completely constant illumination and embodiments in which deviations from a constant illumination of ≤+10%, preferably ≤+5%, more preferably ≤+2% are possible.

The emitting of the flood light and the illumination of the light pattern may be performed subsequently or at at least partially overlapping times. For example, the flood light and the light pattern may be emitted at the same time. For example, one of the flood light or the light pattern may be emitted with a lower intensity compared to the other one.

The projector and the flood illumination source may comprise at least one VCSEL, preferably a plurality of VCSELs. The projector may comprise a plurality of first VCSELs mounted on a first platform. The flood illumination source may comprise a plurality of second VCSELs mounted on a second platform. The second platform may be beside the first platform. The projector may comprise a heat sink. Above the heat sink a first increment comprising the first platform may be attached. Above the heat sink a second increment comprising the second platform may be attached. The second increment may be different from the first increment. Thus, the first platform may be more distant to the optical element configured for increasing, e.g. duplicating, the number of spots. The second platform may be closer to the optical element. The beam emitted from the second VCSEL may be defocused and thus, form overlapping spots. This leads to a substantially continuous illumination and, thus, to flood illumination.

The term “display” as used herein is a broad term and is to be given its ordinary and customary meaning to a person of ordinary skill in the art and is not to be limited to a special or customized meaning. The term specifically may refer, without limitation, to an arbitrary shaped device configured for displaying an item of information. The item of information may be arbitrary information such as at least one image, at least one diagram, at least one histogram, at least one graphic, text, numbers, at least one sign, an operating menu, and the like. The display may be or may comprise at least one display panel. The display may have an arbitrary shape, e.g. a rectangular shape. The display may be a front display of the device. The display may comprise at least one of a display panel, particularly comprising a plurality of pixels and/or a plurality of transistors, or a glass, specifically a cover glass, particularly configured for covering the display panel.

The display, specifically the display panel, may be or may comprise at least one organic light-emitting diode (OLED) display and/or at least one quantum-dot light emitting diode (QLED). As used herein, the term “organic light emitting diode” is a broad term and is to be given its ordinary and customary meaning to a person of ordinary skill in the art and is not to be limited to a special or customized meaning. The term specifically may refer, without limitation, to a light-emitting diode (LED) in which an emissive electroluminescent layer is a film of organic compound configured for emitting light in response to an electric current. The OLED display may be configured for emitting visible light. As used herein, the term “organic light emitting diode” is a broad term and is to be given its ordinary and customary meaning to a person of ordinary skill in the art and is not to be limited to a special or customized meaning. The term specifically may refer, without limitation, to a display technology that utilizes semiconductor particles called quantum dots in order to produce colors on a display. These quantum dots may emit a plurality of different colors of light depending on their size when excited by light. By using a combination of red, green and/or blue quantum dots, a QLED display may display a wide range of colors with high brightness and color accuracy.

The display may be at least partially transparent. The display may be at least partially transparent in at least one continuous areas covering the projector, the flood illumination source and/or the image generation unit. The display may have a transmission below or equal to 20%, preferably below or equal to 15%, more preferably below or equal to 10%. An intensity of a light beam after being projected through the display may correspond to ≤10% of the intensity associated with the light beam when being emitted. The display may have a transmission characteristic of 10%. Preferably the transmission characteristic is below 8%, more preferably below 6%, even more preferably below 5%, even more preferably below 4%, even more preferably below 3%, most preferably below 2.5%.

The display may be at least partially transparent in at least one continuous areas in a manner that at least one of:
the light pattern incident on the continuous areas traverses the display while being illuminated from the projector;
the flood light incident on the continuous areas traverses the display while being illuminated from the flood illumination source;
user light, generated by the light pattern and/or the flood light incident on a user, incident on the continuous areas traverses the display for impinging on the image generation unit.

The term “at least partially transparent” as used herein is a broad term and is to be given its ordinary and customary meaning to a person of ordinary skill in the art and is not to be limited to a special or customized meaning. The term specifically may refer, without limitation, to a property of the display to allow light, in particular of a certain wavelength range, e.g. in the infrared spectral region, in particular in the near infrared spectral region, to pass at least partially through. For example, the display may be semitransparent in the near infrared region. For example, the display may have a transparency of 20% to 50% in the near infrared region. The display may have a different transparency for differing wavelength ranges. The present invention may propose a device comprising the image generation unit and the projector that can be placed behind the display of a device. The transparent area(s) of the display can allow for operation of the image generation unit and the projector behind the display.

The display can be an at least partially transparent display, as described above. The partially transparent contiguous area of the display may be associated with a first pixel density value (Pixels per inch (PPI)), and a further area of the display may be associated with a second pixel density value. The first pixel density value may be lower than the second pixel density value. The transmission of light through the contiguous area may be higher compared to the transmission through the further area. The first pixel density value may be equal or below 450 PPI, preferably between 300 to 440 PPI, more preferably between 350 to 450 PPI. The first pixel density value may be constant over the entire contiguous area with a maximum deviation thereof of 20%, or preferably 10%. The second pixel density value may be between 400 to 500 PPI, preferably between 450 to 500 PPI.

The at least partially transparent continuous area of the display may comprise a first area and a second area. The first area may be associated with a first number of transistors configured for controlling at least one pixel and the second area may be associated with a second number of transistors configured for controlling at least one pixel, and wherein the first number of transistors may be smaller than the second number of transistors. The first number of transistors and/or the second number of transistors may refer to or be a density of the transistors.

The term “pixel” as used herein is a broad term and is to be given its ordinary and customary meaning to a person of ordinary skill in the art and is not to be limited to a special or customized meaning. The term specifically may refer, without limitation, to a picture unit, particularly the smallest picture unit, that represents an addressable element. The entirety of the pixels may represent the display. A pixel may be manipulated by changing its color, brightness and/or contrast or the like. Particularly for manipulating the pixel, the pixel may be driven by at least one transistor, exemplarily a transistor the controls a current required for driving the pixel. Typically, a thin-film transistor may be used for driving the pixel. TFTs may preferably be used in a flat-panel display.

The method comprises directing the first light beam and the second light beam to illuminate an at least partially overlapping area of the user by the display. The term “light beam” as used herein is a broad term and is to be given its ordinary and customary meaning to a person of ordinary skill in the art and is not to be limited to a special or customized meaning. The term specifically may refer, without limitation, to an amount of light, specifically an amount of light traveling essentially in the same direction, including the possibility of the light beam having a spreading angle or widening angle. The light beam specifically may be a Gaussian light beam. Other embodiments are feasible, however. The terms “first” and “second”, are used purely as names and in particular do not give any information about an order and/or about whether, for example, other light beams are present. The term “partial overlap” as used herein is a broad term and is to be given its ordinary and customary meaning to a person of ordinary skill in the art and is not to be limited to a special or customized meaning. The term specifically may refer, without limitation, to at least two light spots projected on a surface of the user illuminating the same area, e.g. completely the same area or at least partially the same area. For example, the overlap may be at least 10%, preferably at least 20%, more preferably at least 50%. Even higher overlap may be possible, e.g. 100%.

For example, a first light spot, e.g. a light spot with a first radius r₁, may illuminate a first area of the user and a second light spot having a second radius r₂, wherein r₁≤r₂, may illuminate a second area of the user. For example, the first area and the second area may be identical or may differ. For example, the first radius may be smaller than the second radius. For example, the first area and the second area may be displaced with respect to each other. All combinations of these examples are possible.

Because of the partial overlap of at least two light spots the intensity in the overlapping region is increased. This can enable accurate and reliable secure authentication even behind a display with low transmissions.

Specifically, the display may have diffraction characteristics. The display may act as grating with a periodic structure that diffracts impinging light from the projector into several beams travelling in different directions, i.e. under different diffraction angles. The diffraction angles may depend on the structure of the display and the wavelength of the incident light. For example, the diffraction of the display may be described by

$$sin ( {θ}_{O L E D , n} ) = n \frac{λ}{d}$$

where n is an integer, A is the wavelength and d is a grid spacing, Θ_{OLED,n} is the diffraction angle of the n-th order and an optical axis (zero order). The design of the pattern of the projector may be selected considering the display diffraction characteristics. In particular, the emission angles of the projector may be selected considering diffraction characteristics of the display. For example, the emission angles of the projector may be selected such that light beams corresponding to minor diffraction orders from the display coincide to other minor or zero orders. The diffraction order n can be positive or negative. The diffraction order may correspond to diffraction orders on both sides of the zero order diffracted light beam. The minor diffraction orders may comprise diffraction orders unequal zero. The minor diffraction orders may be diffractions of the order ±1, ±2, ±3. The term “emission angle” as used herein is a broad term and is to be given its ordinary and customary meaning to a person of ordinary skill in the art and is not to be limited to a special or customized meaning. The term specifically may refer, without limitation, to an angle to the surface normal of the emitter.

The emission angles of the projector may be selected in accordance to the following rule

$$n \cdot k ° \cdot sin {θ}_{O LED , 1} = sin {θ}_{p roj , n}$$

$$k \cdot n \frac{λ}{d} = sin ( {θ}_{p roj , n} )$$

wherein k is a natural number, wherein θ_{proj,n} is the emission angle of the projector, θ_{OLED, 1} is the minimum diffraction angle unequal to zero. The distance d may refer to a pixel to pixel distance in one dimension of the display, in particular of the OLED. Thus, the distance d may define a mesh size of a periodical (pixel) grid.

The emission angles of the projector may be selected, in particular by using the above-mentioned rule, considering potential deviations of the pixel grid from an ideal periodical pixel grid. The relation between the pixel arrangement of the display defined by the distance d between at least two pixels in at least one dimension may have deviation of up to 50%, preferably up to 40%, more preferably up to 25%. Thus, the emission angles θ_{proj,n} of the projector may be selected considering tolerances of ≤50%, preferably ≤40%, more preferably ≤25%.

Using this rule can allow that minor diffraction orders coincide to new or to an original ray (zero order) of the projector. For example, first order and third order spots fall together, and second order spots fall together. Thus, a bundling of light spots may be reached. This can cause less loss of the radiant power of the projector. Another benefit is the elimination or usage of artifacts by adjusting the alignment of the projector and the display such that n-order spots fall together on one spatial position. This can enable accurate and reliable secure authentication even behind a display with low transmissions.

The projector may comprise emitters having inherently a narrow emission profile. For example, a combination of VCSEL and an optical element like MLA, DOE, a meta-surface or lens may be used. Such an arrangement may have a narrower emission profile than off-the-shelf LEDs.

As outlined above, the method comprises generating a pattern image showing the projecting of the plurality of light beams onto the user. The generating of the pattern image may be performed by using at least one image generation unit. The term “image generation unit” as used herein is a broad term and is to be given its ordinary and customary meaning to a person of ordinary skill in the art and is not to be limited to a special or customized meaning. The term specifically may refer, without limitation, to at least one unit of the device configured for generating at least one image. The image may be generated via a hardware and/or a software interface, which may be considered as the image generation unit. The term “image generation”, or “imaging” as used herein is a broad term and is to be given its ordinary and customary meaning to a person of ordinary skill in the art and is not to be limited to a special or customized meaning. The term specifically may refer, without limitation, to capturing and/or generating and/or determining and/or recording at least one image by using the image generation unit. The image generation may comprise imaging and/or recording the image. The image generation may comprise capturing a single image and/or a plurality of images such as a sequence of images. For generating an image via a hardware and/or a software interface, the capturing and/or generating and/or determining and/or recording of the image may be caused and/or initiated by the hardware and/or the software interface. For example, the image generation may comprise recording continuously a sequence of images such as a video or a movie. The image generation may be initiated by a user action or may automatically be initiated, e.g. once the presence of at least one object or user within a field of view and/or within a predetermined sector of the field of view of the image generation unit is automatically detected. The term “field of view” as used herein is a broad term and is to be given its ordinary and customary meaning to a person of ordinary skill in the art and is not to be limited to a special or customized meaning. The term specifically may refer, without limitation, to an angular extent of the observable world and/or at least one scene that may be captured or viewed by an optical system, such as the image generation unit. The field of view may, typically, be expressed in degrees and/or radians, and, exemplarily, may represent the total angle spanned by the image and/or viewable area.

The image generation unit may comprise at least one optical sensor, in particular at least one pixelated optical sensor. The image generation unit may comprise at least one CMOS sensor or at least one CCD chip. For example, the image generation unit may comprise at least one CMOS sensor, which may be sensitive in the infrared spectral range. The term “image” as used herein is a broad term and is to be given its ordinary and customary meaning to a person of ordinary skill in the art and is not to be limited to a special or customized meaning. The term specifically may refer, without limitation, to data recorded by using the optical sensor, such as a plurality of electronic readings from the CMOS or CCD chip. The image may comprise raw image data or may be a pre-processed image. For example, the pre-processing may comprise applying at least one filter to the raw image data and/or at least one background correction and/or at least one background subtraction.

For example, the image generation unit may comprise one or more of at least one monochrome camera e.g. comprising monochrome pixels, at least one color (e.g. RGB) camera e.g. comprising color pixels, at least one IR camera. The camera may be a CMOS camera. The camera may comprise at least one monochrome camera chip, e.g. a CMOS chip. The camera may comprise at least one color camera chip, e.g. an RGB CMOS chip. The camera may comprise at least one IR camera chip, e.g. an IR CMOS chip. For example, the camera may comprise monochrome, e.g. black and white, pixels and color pixels. The color pixels and the monochrome pixels may be combined internally in the camera. The camera generally may comprise a one-dimensional or two-dimensional array of image sensors, such as pixels.

As outlined, above, the image generation unit may be at least one camera. For example, the camera may be an internal and/or external camera of the device. As described in the above, the internal and/or external camera of the device may be accessed via a hardware and/or a software interface, which is used as the image generation unit. In case, the device is or comprises a smartphone the image generating unit may be a front camera, such as a selfie camera, and/or back camera of the smartphone.

The image generation unit may have a field of view between 10°×10° and 75°×75°, preferably 55°×65°. The image generation unit may have a resolution below 2 MP, preferably between 0.3 MP and 1.5 MP.

The image generation unit may comprise further elements, such as one or more optical elements, e.g. one or more lenses. As an example, the optical sensor may be a fix-focus camera, having at least one lens which is fixedly adjusted with respect to the camera. Alternatively, however, the camera may also comprise one or more variable lenses which may be adjusted, automatically or manually. The camera may comprise at least one optical filter, e.g. at least one bandpass filter. The bandpass filter may be matched to the spectrum of the light emitters. Other cameras, however, are feasible.

The term “pattern image” as used herein is a broad term and is to be given its ordinary and customary meaning to a person of ordinary skill in the art and is not to be limited to a special or customized meaning. The term specifically may refer, without limitation, to an image generated by the image generation unit while illuminating with the light pattern, e.g. on an object and/or a user. The pattern image may comprise an image showing a user, in particular at least parts of the face of the user, while the user is being illuminated with the light pattern, particularly on a respective area of interest comprised by the image. The pattern image may be generated by imaging and/or recording light reflected by an object and/or user which is illuminated by the light pattern. The pattern image showing the user may comprise at least a portion of the illuminated light pattern on at least a portion the user. For example, the projection by the projector and the imaging by using the image generation unit may be synchronized, e.g. by using at least one control unit of the device.

As outlined above, the method may comprise emitting flood light by at least one flood illumination source and generating at least one flood image while the flood illumination source is emitting flood light. The term “flood image” as used herein is a broad term and is to be given its ordinary and customary meaning to a person of ordinary skill in the art and is not to be limited to a special or customized meaning. The term specifically may refer, without limitation, to an image generated by the image generation unit while illumination source is emitting infrared flood light, e.g. on an object and/or a user. The flood image may comprise an image showing a user, in particular the face of the user, while the user is being illuminated with the flood light. The flood image may be generated by imaging and/or recording light reflected by an object and/or user which is illuminated by the flood light. The flood image showing the user may comprise at least a portion of the flood light on at least a portion the user. For example, the illumination by the flood illumination source and the imaging by using the image generation unit may be synchronized, e.g. by using at least one control unit of the device.

The image generation unit may be configured for imaging and/or recording the pattern image and the flood image at the same time or at different times. The image generation unit may be configured for imaging and/or recording the pattern image and the flood image at at least partially overlapping measurement areas or equivalents of the measurement areas.

The device may be configured for authenticating a user of the device to perform at least one operation on the device that requires authentication. The device may comprise at least one authentication unit configured for performing at least one authentication process of a user, in particular by using the flood image and the pattern image. The authentication unit may be configured for using a facial recognition authentication process operating on the flood image, the pattern image and/or extracted liveness data, particularly derived from the pattern image.

The term “authentication unit” as used herein is a broad term and is to be given its ordinary and customary meaning to a person of ordinary skill in the art and is not to be limited to a special or customized meaning. The term specifically may refer, without limitation, to at least one unit configured for performing at least one authentication process of a user. The authentication unit may be or may comprise at least one processor and/or may be designed as software or application.

The term “processor” as generally used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. In particular, the processor may be configured for processing basic instructions that drive the computer or system. As an example, the processor may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. In particular, the processor may be a multi-core processor. Specifically, the processor may be or may comprise a central processing unit (CPU). Additionally or alternatively, the processor may be or may comprise a microprocessor, thus specifically the processor's elements may be contained in one single integrated circuitry (IC) chip. Additionally or alternatively, the processor may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The processor specifically may be configured, such as by software programming, for performing one or more evaluation operations. At least one or any component of a computer program configured for performing the authentication process may be executed by the processing device. Alternatively or in addition, the authentication unit may be or may comprise a connection interface. The connection interface may be configured to transfer data from the device to a remote device; or vice versa. At least one or any component of a computer program configured for performing the authentication process may be executed by the remote device.

For example, the authentication unit may perform at least one face detection using the flood image. The face detection may be performed locally on the device. Face identification, i.e. assigning an identity to the detected face, however, may be performed remotely, e.g. in the cloud, e.g. especially when identification needs to be done and not only verification. User templates can be stored at the remote device, e.g. in the cloud, and would not need to be stored locally. This can be an advantage in view of storage space and security.

The authentication unit may be configured for identifying the user based on the flood image. Particularly therefore, the authentication unit may forward data to a remote device. Alternatively or in addition, the authentication unit may perform the identification of the user based on the flood image, particularly by running an appropriate computer program having a respective functionality. The term “identifying” as used herein is a broad term and is to be given its ordinary and customary meaning to a person of ordinary skill in the art and is not to be limited to a special or customized meaning. The term specifically may refer, without limitation, to assigning an identity to a detected face and/or at least one identity check and/or verifying an identity of the user.

The authentication process may comprise a plurality of steps.

For example, the authentication process may comprise performing at least one face detection. The face detection step may comprise analyzing the flood image. In addition, for example, the authentication process may comprise identifying. The identifying may comprise assigning an identity to a detected face and/or at least one identity check and/or verifying an identity of the user. The identifying may comprise performing a face verification of the imaged face to be the user's face. The identifying the user may comprise matching the flood image, e.g. showing a contour of parts of the user, in particular parts of the user's face, with a template. The identifying of the user may comprise determining if the imaged face is the face of the user, in particular if the imaged face corresponds to at least one image of the user's face stored in at least one memory, e.g. of the device. Authentication may be unsuccessful if the flood image cannot be matched with an image template.

The analyzing of the flood image may comprise one or more of the following: a filtering; a selection of at least one region of interest; a formation of a difference image between the flood image and at least one offset; an inversion of flood image; a background correction; a decomposition into color channels; a decomposition into hue; saturation; and brightness channels; a frequency decomposition; a singular value decomposition; applying a Canny edge detector; applying a Laplacian of Gaussian filter; applying a Difference of Gaussian filter; applying a Sobel operator; applying a Laplace operator; applying a Scharr operator; applying a Prewitt operator; applying a Roberts operator; applying a Kirsch operator; applying a high-pass filter; applying a low-pass filter; applying a Fourier transformation; applying a Radon-transformation; applying a Hough-transformation; applying a wavelet-transformation; a thresholding; creating a binary image. The region of interest may be determined manually by a user or may be determined automatically, such as by recognizing the user within the image. In particular, the analyzing of the flood image may comprise using at least one image recognition technique, in particular a face recognition technique. An image recognition technique comprises at least one process of identifying the user in an image. The image recognition may comprise using at least one technique selected from the technique consisting of: color-based image recognition, e.g. using features such as template matching; segmentation and/or blob analysis e.g. using size, or shape; machine learning and/or deep learning e.g. using at least one convolutional neural network.

The analyzing of the flood image may comprise determining a plurality of facial features. The analyzing may comprise comparing, in particular matching, the determined facial features with template features. The template features may be features extracted from at least one template. The template may be or may comprise at least one image generated in an enrollment process, e.g. when initializing the device. Template may be an image of an authorized user. The template features and/or the facial feature may comprise a vector. Matching of the features may comprise determining a distance between the vectors. The identifying of the user may comprise comparing the distance of the vectors to a least one predefined limit, wherein the user is successfully identified in case the distance is ≤the predefined limit at least within tolerances. The user declining and/or rejected otherwise.

For example, the image recognition may comprise using at least one model, in particular a trained model comprising at least one face recognition model. The analyzing of the flood image may be performed by using a face recognition system, such as FaceNet, e.g. as described in Florian Schroff, Dmitry Kalenichenko, James Philbin, “FaceNet: A Unified Embedding for Face Recognition and Clustering”, arXiv: 1503.03832. The trained model may comprises at least one convolutional neural network. For example, the convolutional neural network may be designed as described in M. D. Zeiler and R. Fergus, “Visualizing and understanding convolutional networks”, CoRR, abs/1311.2901, 2013, or C. Szegedy et al., “Going deeper with convolutions”, CORR, abs/1409.4842, 2014. For more details with respect to convolutional neural network for the face recognition system reference is made to Florian Schroff, Dmitry Kalenichenko, James Philbin, “FaceNet: A Unified Embedding for Face Recognition and Clustering”, arXiv: 1503.03832. As training data labelled image data from an image database may be used. Specifically, labeled faces may be used from one or more of G. B. Huang, M. Ramesh, T. Berg, and E. Learned-Miller, “Labeled faces in the wild: A database for studying face recognition in unconstrained environments”, Technical Report 07-49, University of Massachusetts, Amherst, October 2007, the Youtube® Faces Database as described in L. Wolf, T. Hassner, and I. Maoz, “Face recognition in unconstrained videos with matched background similarity”, in IEEE Conf. on CVPR, 2011, or Google® Facial Expression Comparison dataset. The training of the convolutional neural network may be performed as described in Florian Schroff, Dmitry Kalenichenko, James Philbin, “FaceNet: A Unified Embedding for Face Recognition and Clustering”, arXiv: 1503.03832.

As outlined above, the method, e.g. by using the authentication unit, comprises extracting liveness data from the pattern image.

Particularly therefore, the authentication unit may forward data to a remote device. Alternatively or in addition, the authentication unit may perform the extraction of the liveness data based on the pattern image, particularly by running an appropriate computer program having a respective functionality. Particularly by considering the liveness data as a parameter for validating the authentication process, the authentication process may be robust against being outwitted by using a recorded image of the user.

The authentication unit may be configured for outsourcing at least one step of the authentication process, such as the identifying of the user, and/or at least one step of the validation of the authentication process, such as the consideration of the material data, to a remote device, specifically a server and/or a cloud server. The device and the remote device may be part of a computer network, particularly the internet. Thereby, the device may be used as a field device that is used by the user for generating data required in the authentication process and/or its validation. The device may transmit the generated data and/or data associated to an intermediate step of the authentication process and/or its validation to the remote device. In such a scenario, the authentication unit may be and/or may comprise a connection interface configured for transmitting information to the remote device. Data generated by the remote device used in the authentication process and/or its validation may further be transmitted to the device. This data may be received by the connection interface comprised by the device. The connection interface may specifically be configured for transmitting or exchanging information. In particular, the connection interface may provide a data transfer connection. As an example, the connection interface may be or may comprise at least one port comprising one or more of a network or internet port, a USB-port, and a disk drive.

It is emphasized that data from the device may be transmitted to a specific remote device depending on at least one circumstance, such as a date, a day, a load of the specific remote device, and so on. The specific remote device may not be selected by the field device. Rather a further device may select to which specific remote device the data may be transmitted. The authentication process and and/or the generation of validation data may involve a use of several different entities of the remote device. At least one entity may generate intermediate data and transmit the intermediate data to at least one further entity.

The term “liveness data” as used herein is a broad term and is to be given its ordinary and customary meaning to a person of ordinary skill in the art and is not to be limited to a special or customized meaning. The term specifically may refer, without limitation, to data allowing for distinguishing between a living human, in particular a user, and a non-living object such as a paper, 3D facial masks and the like. The liveness data may comprise blood perfusion data and/or material data. Extracting liveness data may comprises extracting material data and/or extracting blood perfusion data. The liveness data may comprise information about a material of the surface of the user on which the spots are projected. The liveness data may comprise information about at least one vital sign.

The method, e.g. by using the authentication unit, may comprise extracting the material data from the pattern image by beam profile analysis of the light spots. With respect to beam profile analysis reference is made to WO 2018/091649 A1, WO 2018/091638 A1 and WO 2018/091640 A1, the full content of which is included by reference. Beam profile analysis can allow for providing a reliable classification of scenes based on a few light spots. Each of the light spots of the pattern image may comprise a beam profile. As used herein, the term “beam profile” may generally refer to at least one intensity distribution of the light spot on the optical sensor as a function of the pixel. The beam profile may be selected from the group consisting of a trapezoid beam profile; a triangle beam profile; a conical beam profile and a linear combination of Gaussian beam profiles.

Extracting material data from the pattern image may comprise generating the material type and/or data derived from the material type. Preferably, extracting material data may be based on the pattern image. Material data may be extracted by using at least one model. Extracting material data may comprise providing the pattern image to a model and/or receiving material data from the model. Providing the pattern image to a model may comprise and may be followed by receiving the pattern image at an input layer of the model or via a model loss function.

The model may be a data-driven model. Data-driven model may comprise a convolutional neural network and/or an encoder decoder structure such as an autoencoder. Other examples for generating a representation may be FFT, wavelets, deep learning, like CNNs, energy models, normalizing flows, GANs, vision transformers, or transformers used for natural language processing, Autoregressive Image Modeling, Normalizing Flows, Deep Autoencoders, Deep Energy-Based Models. Supervised or unsupervised schemes may be applicable to generate a representation, also embedding in e.g. cosine or Euclidian metric in ML language. The data-driven model may be parametrized according to a training data set including at least one image and material data, preferably at least one pattern image and material data. In another embodiment, extracting material data may include providing the pattern image to a model and/or receiving material data from the model. In another embodiment, the data-driven model may be trained according to a training data set including at least one image and material data. In another embodiment, the data-driven model may be parametrized according to a training data set including at least one image and material data. The data-driven model may be parametrized according to a training data set to receive the image and provide material data based on the received image. The data-driven model may be trained according to a training data set to receive the image and provide material data as output based on the received image. The training data set may comprise at least one image and material data, preferably material data associated with the at least one image.

The image may be or may comprise a representation of the image. The representation may be a lower dimensional representation of the image. The representation may comprise at least a part of the data or the information associated with the image. The representation of an image may comprise a feature vector. In an embodiment, determining a representation, in particular a lower-dimensional representation may be based on principal component analysis (PCA) mapping or radial basis function (RBF) mapping. Determining a representation may also be referred to as generating a representation. Generating a representation based on PCA mapping may include clustering based on features in the pattern image and/or partial image. Additionally or alternatively, generating a representation may be based on neural network structures suitable for reducing dimensionality. Neural network structures suitable for reducing dimensionality may comprise encoder and/or decoder. In an example, neural network structure may be an autoencoder. In an example, neural network structure may comprise a convolutional neural network (CNN). The CNN may comprise at least one convolutional layer and/or at least one pooling layer. CNNs may reduce the dimensionality of a partial image and/or an image by applying a convolution, e.g. based on a convolutional layer, and/or by pooling. Applying a convolution may be suitable for selecting feature related to material information of the pattern image.

A model may be suitable for determining an output based on an input. In particular, model may be suitable for determining material data based on an image as input. A model may be a deterministic model, a data-driven model or a hybrid model. The deterministic model, preferably, reflects physical phenomena in mathematical form, e.g., including first-principles models. A deterministic model may comprise a set of equations that describe an interaction between the material and the patterned electromagnetic radiation thereby resulting in a condition measure, a vital sign measure or the like. A data-driven model may be a classification model. A hybrid model may be a classification model comprising at least one machine-learning architecture with deterministic or statistical adaptations and model parameters. Statistical or deterministic adaptations may be introduced to improve the quality of the results since those provide a systematic relation between empiricism and theory. In an embodiment, the data-driven model may be a classification model. The classification model may comprise at least one machine-learning architecture and model parameters. For example, the machine-learning architecture may be or may comprise one or more of: linear regression, logistic regression, random forest, piecewise linear, nonlinear classifiers, support vector machines, naive Bayes classifications, nearest neighbors, neural networks, convolutional neural networks, generative adversarial networks, support vector machines, or gradient boosting algorithms or the like. In the case of a neural network, the model can be a multi-scale neural network or a recurrent neural network (RNN) such as, but not limited to, a gated recurrent unit (GRU) recurrent neural network or a long short-term memory (LSTM) recurrent neural network. The data-driven model may be parametrized according to a training data set. The data-driven model may be trained based on the training data set. Training the model may include parametrizing the model. The term training may also be denoted as learning. The term specifically may refer, without limitation, to a process of building the classification model, in particular determining and/or updating parameters of the classification model. Updating parameters of the classification model may also be referred to as retraining. Retraining may be included when referring to training herein. In an embodiment, the training data set may include at least one image and material information.

Extracting material data from the image with a data-driven model may comprise providing the image to a data-driven model. Additionally or alternatively, extracting material data from the image with a data-driven model may comprise may comprise generating an embedding associated with the image based on the data-driven model. An embedding may refer to a lower dimensional representation associated with the image such as a feature vector. Feature vector may be suitable for suppressing the background while maintaining the material signature indicating the material data. In this context, background may refer to information independent of the material signature and/or the material data. Further, background may refer to information related to biometric features such as facial features. Material data may be determined with the data-driven model based on the embedding associated with the image. Additionally or alternatively, extracting material data from the image by providing the image to a data-driven model may comprise transforming the image into material data, in particular a material feature vector indicating the material data. Hence, material data may comprise further the material feature vector and/or material feature vector may be used for determining material data.

The authentication process may be validated based on the extracted material data. In an embodiment, the validating based on the extracted material data may comprise determining if the extracted material data corresponds a desired material data. Determining if extracted material data matches the desired material data may be referred to as validating. Allowing or declining the user and/or object to perform at least one operation on the device that requires authentication based on the material data may comprise validating the authentication or authentication process. Validating may be based on material data and/or image. Determining if the extracted material data corresponds a desired material data may comprise determining a similarity of the extracted material data and the desired material data. Determining a similarity of the extracted material data and the desired material data may comprise comparing the extracted material data with the desired material data. Desired material data may refer to predetermined material data. In an example, desired material data may be skin. It may be determined if material data may correspond to the desired material data. In the example, material data may be non-skin material or silicon. Determining if material data corresponds to a desired material data may comprise comparing material data with desired material data. A comparison of material data with desired material data may result in a allowing and/or declining the user and/or object to perform at least one operation that requires authentication. In the example, skin as desired material data may be compared with non-skin material or silicon as material data and the result may be declination since silicon or non-skin material may be different from skin.

The authentication process or its validation may include generating at least one feature vector from the material data and matching the material feature vector with associate reference template vector for material.

Additionally or alternatively of using material data, the method may comprise extracting blood perfusion data. For example, the light beams projected by the projector may be coherent patterned infrared illumination. Extracting blood perfusion data may comprise determining a speckle contrast of the pattern image and determining a blood perfusion measure based on the determined speckle contrast. A speckle contrast may represents a measure for a mean contrast of an intensity distribution within an area of a speckle pattern. In particular, a speckle contrast K over an area of the speckle pattern may be expressed as a ratio of standard deviation σ to the mean speckle intensity <I>, i.e.,

$$K = \frac{σ}{〈 I 〉}$$

Speckle contrast may comprise a speckle contrast value. Speckle contrast values may be distributed between 0 and 1. The blood perfusion measure may be determined based on the speckle contrast.

The blood perfusion measure may depend on the determined speckle contrast. If the speckle contrast changes, the blood perfusion measure derived from the speckle contrast may change accordingly. A blood perfusion measure may be a single number or value that may represent a likelihood that the object is a living subject.

For example, for determining the speckle contrast, the complete pattern image may be used. Alternatively, for determining the speckle contrast, a section of the pattern image may be used. The section of the pattern image, preferably, represents a smaller area of the pattern image than an area of the complete pattern image. The section of the pattern image may be obtained by cropping the pattern image.

In an embodiment, a data-driven model may be used for determining a blood perfusion measure. Data-driven model be parametrized and/or trained based on a training data set. The training data set may comprise a pattern image and a blood perfusion measure. The data-driven model may be parametrized and/or trained based on the training data set to output a blood perfusion measure based on receiving a pattern image.

The authentication process may be validated based on the blood perfusion measure. In an embodiment, the validating based on the blood perfusion measure may comprise determining if the blood perfusion measure corresponds to blood perfusion measure of a human being. Determining if the blood perfusion measure corresponds a human being may be referred to as validating. Allowing or declining the user and/or object to perform at least one operation on the device that requires authentication based on the blood perfusion measure may comprise validating the authentication or authentication process. Validating may be based on the blood perfusion measure. Determining if the blood perfusion measure corresponds a human being may comprise comparing the blood perfusion measure to at least one pre-defined or pre-determined range of values of blood perfusion measure, e.g. stored in at least one database. In case the extracted blood perfusion measure is at least within tolerances within the re-defined or pre-determined range of values of blood perfusion measure, the authentication is validated, otherwise not. In case the authentication is validated the method may comprise allowing the user to perform at least one operation that requires authentication. Otherwise, in case the authentication is not validated the method may comprise declining the user to perform at least one operation that requires authentication.

The method comprises allowing the user to perform an operation on the device that requires authentication based on the liveness data, e.g. by using at least one authorization unit. In particular, the method may comprise at least authorization step, e.g. by using at least one authorization unit. The term “authorization step” as used herein is a broad term and is to be given its ordinary and customary meaning to a person of ordinary skill in the art and is not to be limited to a special or customized meaning. The term specifically may refer, without limitation, to a step of assigning access rights to the user, in particular a selective permission or selective restriction of access to the device and/or at least one resource of the device. The authorization unit may be configured for access control. The term “authorization unit” as used herein is a broad term and is to be given its ordinary and customary meaning to a person of ordinary skill in the art and is not to be limited to a special or customized meaning. The term specifically may refer, without limitation, to a unit such as a processor configured for authorization of a user. The authorization unit may comprise at least one processor or may be designed as software or application. The authorization unit and the authentication unit may be embodied integral, e.g. by using the same processor. The authorization unit may be configured for allowing the user to perform at least one operation on the device, e.g. unlocking the device, in case of successful authentication of the user or declining the user to perform at least one operation on the device in case of non-successful authentication. Thereby, the user may become aware of the result of the authentication. The method may comprise displaying the result of the authentication on the display.

At least one operation on the device that requires authentication may be access to the device, e.g. unlocking the device, and/or access to an application, preferably associated with the device and/or access to a part of an application, preferably associated with the device. In an embodiment, allowing the user to access a resource may include allowing the user to perform at least one operation with a device and/or system. The resource may be a device, a system, a function of a device, a function of a system and/or an entity. Additionally and/or alternatively, allowing the user to access a resource may include allowing the user to access an entity. The entity may be a physical entity and/or a virtual entity. The virtual entity may be a database for example.

The physical entity may be an area with restricted access. The area with restricted access may be one of the following: security areas, rooms, apartments, vehicles, parts of the before mentioned examples, or the like. Device and/or system may be locked. The device and/or the system may only be unlocked by an authorized user.

All described method steps may be performed by using the device. Therefore, a single processing device may be configured to exclusively perform at least one computer program, in particular at least one line of computer program code configured to execute at least one algorithm, as used in at least one of the embodiments of the method according to the present invention. Herein, the computer program as executed on the single processing device may comprise all instructions causing the computer to carry out the method. Alternatively, or in addition, at least one method step may be performed by using at least one remote device, especially selected from at least one of a server or a cloud server, particularly when the device and the remote device may be part of a computer network. In this case, the computer program may comprise at least one remote component to be executed by the at least one remote processing device to carry out the at least one method step. The remote component may have the functionality of performing the identifying of the user and/or the extraction of the material data. Further, the computer program may comprise at least one interface configured to forward to and/or receive data from the at least one remote component of the computer program.

In a further aspect, a device for authenticating a user is disclosed. The device comprises:
at least one projector configured for projecting the plurality of light beams through at least one display, in particular of the device, onto the user, wherein the plurality of light beams comprises a first light beam and a second light beam, and directing the first light beam and the second light beam to illuminate an at least partially overlapping area of the user by the display,
at least one image generation unit configured for generating a pattern image showing the projecting of the plurality of light beams onto the user;
at least one processor configured for extracting liveness data from the pattern image and allowing the user to perform an operation on the device that requires authentication based on the liveness data.

For details, options and definitions of the device, reference may be made to the method as discussed above. Thus, specifically, the device may be configured for performing the method according to the present invention, such as according the above or given in further detail below. Reference may, therefore, be made to any further aspect of the present disclosure.

In a further aspect, a computer program is disclosed, which comprises instructions which, when the program is executed by the device, cause the device to perform the method according to any one of the preceding embodiments referring to a method. Specifically, the computer program may be stored on a computer-readable data carrier and/or on a computer-readable storage medium. The computer program may be executed on at least one processor comprised by the device. The computer program may generate input data by accessing and/or controlling at least one unit of the device, such as the projector and/or the flood illumination source and/or the image generation unit. The computer program may generate outcome data based on the input data, particularly by using the authentication unit.

As used herein, the terms “computer-readable data carrier” and “computer-readable storage medium” specifically may refer to non-transitory data storage means, such as a hardware storage medium having stored thereon computer-executable instructions. The stored computer-executable instruction may be associate with the computer program. The computer-readable data carrier or storage medium specifically may be or may comprise a storage medium such as a random-access memory (RAM) and/or a read-only memory (ROM).

Thus, specifically, one, more than one or even all of method steps a. to e. as indicated above may be performed by using a computer or a computer network, preferably by using a computer program.

Further disclosed and proposed herein is a computer program product having program code means, in order to perform the method according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method according to one or more of the embodiments disclosed herein.

Further disclosed and proposed herein is a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Further disclosed and proposed herein is a non-transient computer-readable medium including instructions that, when executed by one or more processors, cause the one or more processors to perform the method according to one or more of the embodiments disclosed herein.

Finally, disclosed and proposed herein is a modulated data signal which contains instructions readable by a computer system or computer network, for performing the method according to one or more of the embodiments disclosed herein.

Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Summarizing and without excluding further possible embodiments, the following embodiments may be envisaged:
Embodiment 1. A method for authenticating a user of a device, the method comprising:
   a. projecting a plurality of light beams through a display onto the user by a projector, wherein the plurality of light beams comprises a first light beam and a second light beam, and directing the first light beam and the second light beam to illuminate an at least partially overlapping area of the user by the display,
   b. generating a pattern image showing the projecting of the plurality of light beams onto the user,
   C. extracting liveness data from the pattern image,
   d. allowing the user to perform an operation on the device that requires authentication based on the liveness data.
Embodiment 2. The method according to the preceding embodiment, wherein the emission angles of the projector are selected considering diffraction characteristics of the display.
Embodiment 3. The method according to the preceding embodiment, wherein the emission angles of the projector are selected such that light beams corresponding to minor diffraction orders from the display coincide to other minor or zero orders.
Embodiment 4. The method according to any one of the preceding embodiments, wherein the emission angles of the projector are selected in accordance to the following rule

$$k \cdot n \frac{λ}{d} = sin ( {θ}_{p roj , n} )$$

wherein n is an integer, k is a natural number, λ is the wavelength and d is a pixel to pixel distance in one dimension of the display wherein θ_{proj,n} is the emission angle of the projector.
Embodiment 5. The method according to any one of the preceding embodiments, wherein the emission angles of the projector are selected considering tolerances of ≤50%, preferably ≤40%, more preferably ≤25%.
Embodiment 6. The method according to any one of the preceding embodiments, wherein a number of light beams projected on the user is lower than 5000, preferably lower than 3000, more preferably lower than 2000, even more preferably below 1500, most preferably below 1000.
Embodiment 7. The method according to any one of the preceding embodiments, wherein the projector projects at least one infrared light pattern, wherein the projected light beams have a wavelength in the infrared spectral range, preferably from 800 nm to 1300 nm, more preferably from 900 nm to 1000 nm, most preferably from 1100 nm to 1200 nm.
Embodiment 8. The method according to any one of the preceding embodiments, wherein the projector comprises at least one least one emitter selected from the group consisting of: at least one laser source such as at least one semi-conductor laser, at least one double heterostructure laser, at least one external cavity laser, at least one separate confinement heterostructure laser, at least one quantum cascade laser, at least one distributed Bragg reflector laser, at least one polariton laser, at least one hybrid silicon laser, at least one extended cavity diode laser, at least one quantum dot laser, at least one volume Bragg grating laser, at least one Indium Arsenide laser, at least one Gallium Arsenide laser, at least one transistor laser, at least one diode pumped laser, at least one distributed feedback lasers, at least one quantum well laser, at least one interband cascade laser, at least one semiconductor ring laser, at least one vertical cavity surface emitting laser (VCSEL); at least one non-laser light source such as at least one LED or at least one light bulb; at least one edge-emitting laser.
Embodiment 9. The method according to any one of the preceding embodiments, wherein the display is configured for modifying light spots generated by the projector when traversing the display, and/or wherein the projector comprises at least one optical element selected from the group consisting of: at least one lens; at least one Micro-lens-array (MLA); at least one diffractive optical element (DOE); and at least one meta surface element.
Embodiment 10. The method according to any one of the preceding embodiments, the method comprises emitting flood light by at least one flood illumination source and generating at least one flood image while the flood illumination source is emitting flood light.
Embodiment 11. The method according to any one of the preceding embodiments, wherein the display is or comprises at least one organic light-emitting diode (OLED) display and/or at least one quantum-dot light emitting diode (QLED) display.
Embodiment 12. The method according to any one of the preceding embodiments, wherein the display is at least partially transparent in at least one continuous area covering the projector and/or an image generation unit, wherein the display has a transmission below or equal to 20%, preferably below or equal to 15%, more preferably below or equal to 10%.
Embodiment 13. The method according to any one of the preceding embodiments, wherein an intensity of a light beam after being projected through the display corresponds to ≤10% of the intensity associated with the light beam when being emitted, wherein the display has a transmission characteristic of 10%, preferably the transmission characteristic is below 8%, more preferably below 6%, even more preferably below 5%, even more preferably below 4%, even more preferably below 3%, most preferably below 2.5%.
Embodiment 14. The method according to any one of the two preceding embodiments, wherein the partially transparent contiguous area is associated with a first pixel density value (Pixels per inch (PPI)), and a further area of the display is associated with a second pixel density value, wherein the display has the first pixel density value is equal or below 450 PPI, preferably between 300 to 440 PPI, more preferably between 350 to 450 PPI, wherein the first pixel density value is constant over the entire contiguous area with a maximum deviation thereof of 20%, or preferably 10%, wherein the second pixel density value is between 400 to 500 PPI, preferably between 450 to 500 PPI.
Embodiment 15. The method according to any one of the preceding embodiments, wherein the liveness data comprises blood perfusion data and/or material data.
Embodiment 16. The method according to any one of the preceding embodiments, wherein extracting liveness data comprises extracting material data and/or extracting blood perfusion data.
Embodiment 17. The method according to the preceding embodiment, wherein extracting material data comprises providing the pattern image to a model and/or receiving material data from the model.
Embodiment 18. The method according to any one of the two preceding embodiments, wherein extracting blood perfusion data comprises determining a speckle contrast of the pattern image and determining a blood perfusion measure based on the determined speckle contrast, wherein a speckle contrast represents a measure for a mean contrast of an intensity distribution within an area of a speckle pattern.
Embodiment 19. The method according to any one of the preceding embodiments, wherein the device is selected from the group consisting of: a television device; a game console; a personal computer; a mobile device, particularly a cell phone, and/or a smart phone, and/or, and/or a tablet computer, and/or a laptop, and/or a tablet, and/or a virtual reality device, and/or a wearable, such as a smart watch; or another type of portable computer.
Embodiment 20. The method according to any one of the preceding embodiments, wherein the method is computer-implemented.
Embodiment 21. A device for authenticating a user, the device comprising:
   at least one projector configured for projecting the plurality of light beams through at least one display onto the user, wherein the plurality of light beams comprises a first light beam and a second light beam, and directing the first light beam and the second light beam to illuminate an at least partially overlapping area of the user by the display,
   at least one image generation unit configured for generating a pattern image showing the projecting of the plurality of light beams onto the user;
   at least one processor configured for extracting liveness data from the pattern image and allowing the user to perform an operation on the device that requires authentication based on the liveness data.
Embodiment 22. The device according to the preceding embodiment, wherein the device comprises the display configured for directing the light beams to illuminate an at least partially overlapping area of the user.
Embodiment 23. The device according to any one of the preceding embodiments referring to a device, wherein the device is configured for performing the method according to any one of the preceding embodiments referring to a method.
Embodiment 24. A computer program comprising instructions which, when the program is executed by the device according to any one of the preceding embodiments referring to a device, cause the device to perform the method according to any one of the preceding embodiments referring to a method.
Embodiment 25. A computer-readable storage medium comprising instructions which, when the instructions are executed by the device according to any one of the preceding embodiments referring to a device, cause the device to perform the method according to any one of the preceding embodiments referring to a method.
Embodiment 26. A non-transient computer-readable medium including instructions that, when executed by one or more processors, cause the one or more processors to perform the method according to any one of the preceding embodiments referring to a method.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows an embodiment of a device according to the present invention;

FIGS. 2A and 2B show an exemplary display and its diffraction characteristics, and emission angles of a projector;

FIGS. 3A to 3C shows exemplary light pattern (3A), diffraction pattern (3B) and resulting pattern at the user; and

FIG. 4 shows a flow chart of an exemplary embodiment of a method for authenticating a user of a device.

### DETAILED DESCRIPTION OF THE EMBODIMENTS

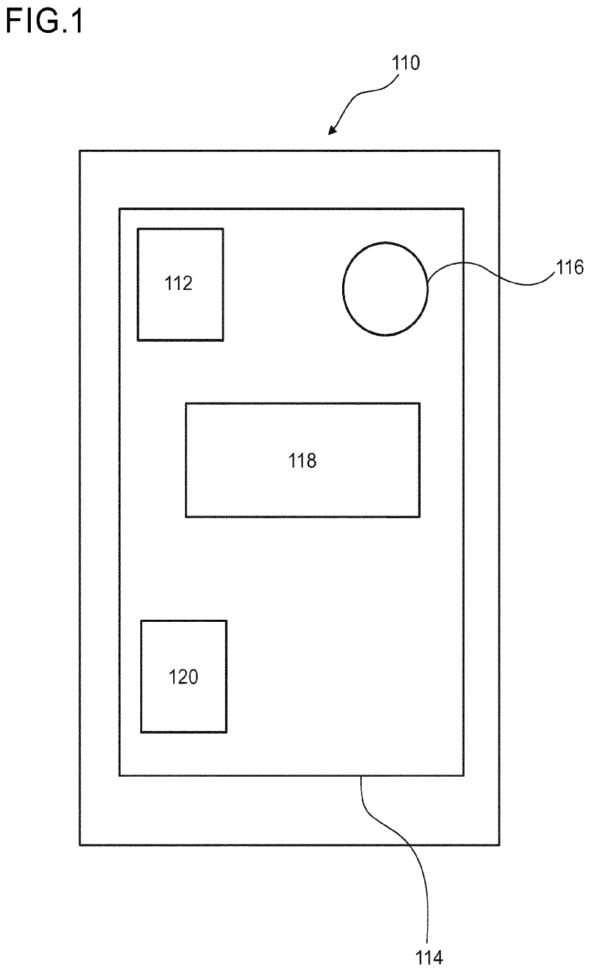

FIG. 1 shows an embodiment of a device 110 for authenticating a user of the present invention in a highly schematic fashion.

For example, the device 110 may be selected from the group consisting of: a television device; a game console; a personal computer; a mobile device, particularly a cell phone, and/or a smart phone, and/or a tablet computer, and/or a laptop, and/or a tablet, and/or a virtual reality device, and/or a wearable, such as a smart watch; or another type of portable computer.

The device 110 comprises:
at least one projector 112 configured for projecting the plurality of light beams through at least one display 114 of the device 110 onto the user, wherein the plurality of light beams comprises a first light beam and a second light beam, and directing the first light beam and the second light beam to illuminate an at least partially overlapping area of the user by the display 114,
at least one image generation unit 116 configured for generating a pattern image showing the projecting of the plurality of light beams onto the user;
at least one processor 118 configured for extracting liveness data from the pattern image and allowing the user to perform an operation on the device 110 that requires authentication based on the liveness data.

The projector 112 may be configured for generating and/or for providing at least one light pattern, in particular at least one infrared light pattern. The light pattern may be an infrared light pattern. Specifically, the projector 112 may be configured for projecting at least one infrared light pattern, wherein the projected light beams have a wavelength in the infrared spectral range, preferably from 800 nm to 1300 nm, more preferably from 900 nm to 1000 nm, most preferably from 1100 nm to 1200 nm.

The light projected by the projector 112 may be coherent. The light pattern may be a coherent, in particular infrared, light pattern. The projector 112 may be configured for emitting light at a single wavelength, e.g. in the near infrared region. In other embodiments, the projector 112 may be adapted to emit light with a plurality of wavelengths, e.g. for allowing additional measurements in other wavelengths channels.

The light pattern may comprise at least one regular and/or constant and/or periodic pattern such as a triangular pattern, a rectangular pattern, a hexagonal pattern or a pattern comprising further convex tilings. For example, the light pattern is a hexagonal pattern, preferably a hexagonal light pattern, preferably a ⅖ hexagonal infrared light pattern. Using a periodical ⅖ hexagonal pattern can allow distinguishing between artefacts and usable signal.

The light pattern may comprise at least one point pattern. The light pattern has a low point density. For example, a number of light beams projected on the user is lower than 5000, preferably lower than 3000, more preferably lower than 2000, even more preferably below 1500, most preferably below 1000.

The projector 112 may comprise at least one least one emitter, in particular a plurality of emitters. The emitter may be selected from the group consisting of: at least one laser source such as at least one semi-conductor laser, at least one double heterostructure laser, at least one external cavity laser, at least one separate confinement heterostructure laser, at least one quantum cascade laser, at least one distributed Bragg reflector laser, at least one polariton laser, at least one hybrid silicon laser, at least one extended cavity diode laser, at least one quantum dot laser, at least one volume Bragg grating laser, at least one Indium Arsenide laser, at least one Gallium Arsenide laser, at least one transistor laser, at least one diode pumped laser, at least one distributed feedback lasers, at least one quantum well laser, at least one interband cascade laser, at least one semiconductor ring laser, at least one vertical cavity surface emitting laser (VCSEL); at least one non-laser light source such as at least one LED or at least one light bulb; at least one edge-emitting laser.

The display 114 may be configured for modifying the spots, e.g. by increasing a number of spots, generated by the projector 112 when traversing the display 114. For example, the display 114 may act as diffractive optical element (DOE). Thus, resources can be saved since the display functions as DOE and such that no further DOE is necessary. Moreover, less emitter, e.g. VCSEL cavities, are necessary since the light beams can be multiplicated by the display 114. Additionally or alternatively, the projector 112 may comprise at least one optical element, e.g. configured for modifying the spots, e.g. by increasing a number of spots, selected from the group consisting of: at least one lens; at least one Micro-lens-array (MLA); at least one diffractive optical element (DOE); and at least one meta surface element. The DOE and/or the metasurface element may be configured for generating multiple light beams from a single incoming light beam. For example, a VCSEL projecting up to 2000 spots and an optical element comprising a plurality of metasurface elements may be used to duplicate the number of spots. Further arrangements, particularly comprising a different number of projecting VCSEL and/or at least one different optical element configured for increasing the number of spots may be possible. Other multiplication factors are possible. For example, a VCSEL or a plurality of VCSELs may be used and the generated laser spots may be duplicated by using at least one DOE.

The device further comprises at least one flood illumination source 120 configured for emitting flood light. The image generation unit 116 may be configured for generating at least one flood image while the flood illumination source 120 is emitting flood light. The flood light may have a wavelength in the infrared range, in particular in the near infrared range. The flood illumination source 120 may comprise at least one LED or at least one VCSEL, preferably a plurality of VCSELs. The emitting of the flood light and the illumination of the light pattern may be performed subsequently or at at least partially overlapping times. For example, the flood light and the light pattern may be emitted at the same time. For example, one of the flood light or the light pattern may be emitted with a lower intensity compared to the other one.

The display 114, specifically the display panel, may be or may comprise at least one organic light-emitting diode (OLED) display and/or at least one quantum-dot light emitting diode (QLED).

The display 114 may be at least partially transparent. The display 114 may be at least partially transparent in at least one continuous areas covering the projector, the flood illumination source and/or the image generation unit. The display 114 may have a transmission below or equal to 20%, preferably below or equal to 15%, more preferably below or equal to 10%. An intensity of a light beam after being projected through the display 114 may correspond to ≤10% of the intensity associated with the light beam when being emitted. The display 114 may have a transmission characteristic of 10%. Preferably the transmission characteristic is below 8%, more preferably below 6%, even more preferably below 5%, even more preferably below 4%, even more preferably below 3%, most preferably below 2.5%.

The display 114 may be at least partially transparent in at least one continuous areas in a manner that at least one of:
the light pattern incident on the continuous areas traverses the display 114 while being illuminated from the projector 112;
the flood light incident on the continuous areas traverses the display 114 while being illuminated from the flood illumination source 120;
user light, generated by the light pattern and/or the flood light incident on a user, incident on the continuous areas traverses the display 114 for impinging on the image generation unit 116.

For example, the display 114 may be semitransparent in the near infrared region. For example, the display 114 may have a transparency of 20% to 50% in the near infrared region. The display 114 may have a different transparency for differing wavelength ranges. The present invention may propose a device 110 comprising the image generation unit 116 and the projector 112 that can be placed behind the display 114 of a device. The transparent area(s) of the display 114 can allow for operation of the image generation unit 116 and the projector 112 behind the display 114.

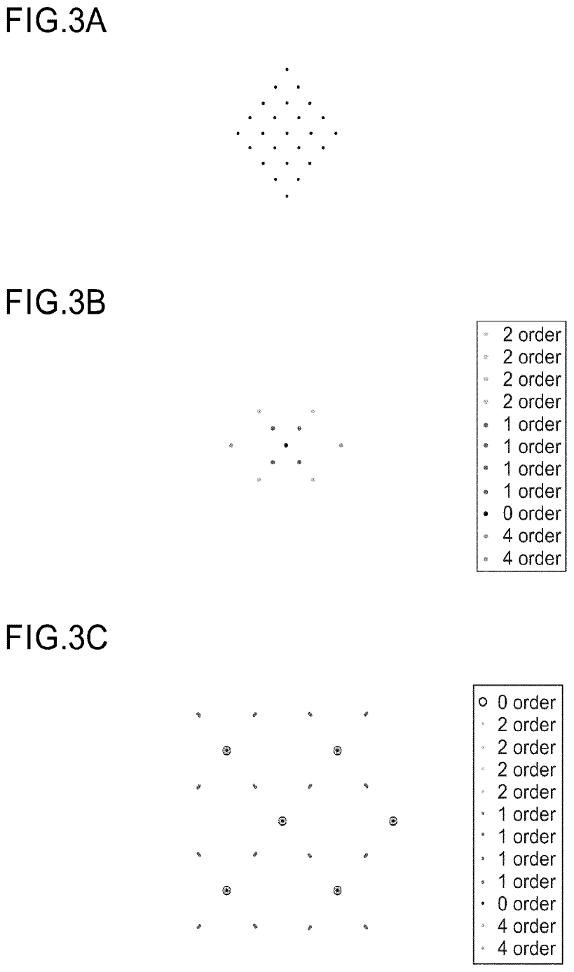

The projector 112 is configured for directing the first light beam and the second light beam to illuminate an at least partially overlapping area of the user by the display 114. For example, the overlap may be at least 10%, preferably at least 20%, more preferably at least 50%. Even higher overlap may be possible, e.g. 100%. For example, a first light spot, e.g. a light spot with a first radius r₁, may illuminate a first area of the user and a second light spot having a second radius r₂, wherein r₁≤r₂, may illuminate a second area of the user. For example, the first area and the second area may be identical or may differ. For example, the first radius may be smaller than the second radius. For example, the first area and the second area may be displaced with respect to each other. All combinations of these examples are possible. Because of the partial overlap of at least two light spots the intensity in the overlapping region is increased. This can enable accurate and reliable secure authentication even behind a display with low transmissions. Exemplary at least partially overlapping light spots are shown in FIG. 3C.

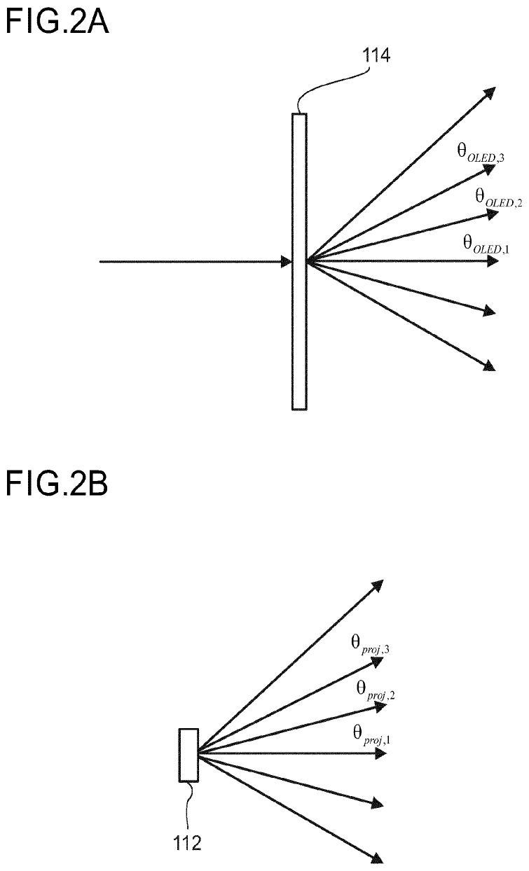

The display 114 may have diffraction characteristics. The display 114 may act as grating with a periodic structure that diffracts impinging light from the projector 112 into several beams travelling in different directions, i.e. under different diffraction angles. FIG. 2A depicts an exemplary display 114, wherein an impinging light beam is diffracted under diffraction angles θ_{OLED,n} (in this example n=1, 2, 3). The diffraction angles may depend on the structure of the display 114 and the wavelength of the incident light. For example, the diffraction of the display 114 may be described by

$$sin ( {θ}_{O L E D , n} ) = n \frac{λ}{d}$$

where n is an integer, A is the wavelength and d is a grid spacing, Θ_{OLED,n} is the diffraction angle of the n-th order and an optical axis (zero order). The design of the pattern of the projector 112 may be selected considering the display 114 diffraction characteristics. FIG. 2B shows exemplary emission angles θ_{proj,i} (with i=1, 2, 3 in this example) of the projector 112. In particular, the emission angles of the projector 112 may be selected considering diffraction characteristics of the display 114 such that light beams corresponding to minor diffraction orders from the display 114 coincide to other minor or zero orders.

The emission angles of the projector 112 may be selected in accordance to the following rule

$$n \cdot k ° \cdot sin {θ}_{O LED , 1} = sin {θ}_{p roj , n}$$

$$k \cdot n \frac{λ}{d} = sin ( {θ}_{p roj , n} )$$

wherein k is a natural number, wherein θ_{proj,n} in is the emission angle of the projector 112, θ_{OLED,1} is the minimum diffraction angle unequal to zero. The distance d may refer to a pixel to pixel distance in one dimension of the display 114, in particular of the OLED. Thus, the distance d may define a mesh size of a periodical (pixel) grid.

The emission angles of the projector 112 may be selected, in particular by using the above-mentioned rule, considering potential deviations of the pixel grid from an ideal periodical pixel grid. The relation between the pixel arrangement of the display 114 defined by the distance d between at least two pixels in at least one dimension may have deviation of up to 50%, preferably up to 40%, more preferably up to 25%. Thus, the emission angles θ_{proj,n} of the projector may be selected considering tolerances of up to 50%, preferably up to 40%, more preferably up to 25%.

Using this rule can allow that minor diffraction orders coincide to new or to an original ray (zero order) of the projector 112.

FIG. 3A shows an exemplary light pattern generated by the projector 112. FIG. 3B an exemplary diffraction pattern of the display 114. FIG. 3C shows the resulting pattern at the user. In this example, first order and third order spots fall together, and second order spots fall together. Thus, a bundling of light spots may be reached. This can cause less loss of the radiant power of the projector. Another benefit is the elimination or usage of artifacts by adjusting the alignment of the projector and the display such that n-order spots fall together on one spatial position. This can enable accurate and reliable secure authentication even behind a display with low transmissions.

The projector 112 may comprise emitters having inherently a narrow emission profile. For example, a combination of VCSEL and an optical element like MLA, DOE, a meta-surface or lens may be used. Such an arrangement may have a narrower emission profile than off-the-shelf LEDs.

Back to FIG. 1, the image generation unit 116 may comprise at least one optical sensor, in particular at least one pixelated optical sensor. The image generation unit may comprise at least one CMOS sensor or at least one CCD chip. For example, the image generation unit 116 may comprise at least one CMOS sensor, which may be sensitive in the infrared spectral range. The image may comprise raw image data or may be a pre-processed image. For example, the preprocessing may comprise applying at least one filter to the raw image data and/or at least one background correction and/or at least one background subtraction.

For example, the image generation unit 116 may comprise one or more of at least one monochrome camera e.g. comprising monochrome pixels, at least one color (e.g. RGB) camera e.g. comprising color pixels, at least one IR camera. The camera may be a CMOS camera. The camera may comprise at least one monochrome camera chip, e.g. a CMOS chip. The camera may comprise at least one color camera chip, e.g. an RGB CMOS chip. The camera may comprise at least one IR camera chip, e.g. an IR CMOS chip. For example, the camera may comprise monochrome, e.g. black and white, pixels and color pixels. The color pixels and the monochrome pixels may be combined internally in the camera. The camera generally may comprise a one-dimensional or two-dimensional array of image sensors, such as pixels. For example, the camera may be an internal and/or external camera of the device 110. As described in the above, the internal and/or external camera of the device may be accessed via a hardware and/or a software interface, which is used as the image generation unit 116. In case, the device 110 is or comprises a smartphone the image generating unit may be a front camera, such as a selfie camera, and/or back camera of the smartphone.

The image generation unit 116 may have a field of view between 10°×10° and 75°×75°, preferably 55°×65°. The image generation unit 116 may have a resolution below 2 MP, preferably between 0.3 MP and 1.5 MP.

The image generation unit 116 may comprise further elements, such as one or more optical elements, e.g. one or more lenses. As an example, the optical sensor may be a fix-focus camera, having at least one lens which is fixedly adjusted with respect to the camera. Alternatively, however, the camera may also comprise one or more variable lenses which may be adjusted, automatically or manually. The camera may comprise at least one optical filter, e.g. at least one bandpass filter. The bandpass filter may be matched to the spectrum of the light emitters. Other cameras, however, are feasible.

The pattern image may comprise an image showing a user, in particular at least parts of the face of the user, while the user is being illuminated with the light pattern, particularly on a respective area of interest comprised by the image. The pattern image may be generated by imaging and/or recording light reflected by an object and/or user which is illuminated by the infrared light pattern. The pattern image showing the user may comprise at least a portion of the illuminated light pattern on at least a portion the user. For example, the projection by the projector 112 and the imaging by using the image generation unit 116 may be synchronized, e.g. by using at least one control unit of the device 110.

The flood image may comprise an image showing a user, in particular the face of the user, while the user is being illuminated with the flood light. The flood image may be generated by imaging and/or recording light reflected by an object and/or user which is illuminated by the flood light. The flood image showing the user may comprise at least a portion of the flood light on at least a portion the user. For example, the illumination by the flood illumination source 120 and the imaging by using the image generation unit 116 may be synchronized, e.g. by using at least one control unit of the device 110.

The image generation unit 116 may be configured for imaging and/or recording the pattern image and the flood image at the same time or at different times. The image generation unit 116 may be configured for imaging and/or recording the pattern image and the flood image at at least partially overlapping measurement areas or equivalents of the measurement areas.

The device 110 may be configured for authenticating a user of the device 110 to perform at least one operation on the device that requires authentication. The device 110 may comprise at least one authentication unit (e.g. processor 118) configured for performing at least one authentication process of a user, in particular by using the flood image and the pattern image. The authentication unit may be configured for using a facial recognition authentication process operating on the flood image, the pattern image and/or extracted liveness data, particularly derived from the pattern image. The authentication unit may be or may comprise at least one processor and/or may be designed as software or application.

For example, the authentication unit may perform at least one face detection using the flood image. The face detection may be performed locally on the device. Face identification, i.e. assigning an identity to the detected face, however, may be performed remotely, e.g. in the cloud, e.g. especially when identification needs to be done and not only verification. User templates can be stored at the remote device, e.g. in the cloud, and would not need to be stored locally. This can be an advantage in view of storage space and security.

The authentication unit may be configured for identifying the user based on the flood image. Particularly therefore, the authentication unit may forward data to a remote device. Alternatively or in addition, the authentication unit may perform the identification of the user based on the flood image, particularly by running an appropriate computer program having a respective functionality. The identifying may comprise assigning an identity to a detected face and/or at least one identity check and/or verifying an identity of the user.

For example, the authentication process may comprise performing at least one face detection. The face detection step may comprise analyzing the flood image. In addition, for example, the authentication process may comprise identifying. The identifying may comprise assigning an identity to a detected face and/or at least one identity check and/or verifying an identity of the user. The identifying may comprise performing a face verification of the imaged face to be the user's face. The identifying the user may comprise matching the flood image, e.g. showing a contour of parts of the user, in particular parts of the user's face, with a template. The identifying of the user may comprise determining if the imaged face is the face of the user, in particular if the imaged face corresponds to at least one image of the user's face stored in at least one memory, e.g. of the device. Authentication may be unsuccessful if the flood image cannot be matched with an image template.

The analyzing of the flood image may comprise determining a plurality of facial features. The analyzing may comprise comparing, in particular matching, the determined facial features with template features. The template features may be features extracted from at least one template. The template may be or may comprise at least one image generated in an enrollment process, e.g. when initializing the device. Template may be an image of an authorized user. The template features and/or the facial feature may comprise a vector. Matching of the features may comprise determining a distance between the vectors. The identifying of the user may comprise comparing the distance of the vectors to a least one predefined limit, wherein the user is successfully identified in case the distance is ≤the predefined limit at least within tolerances. The user declining and/or rejected otherwise.

For example, the image recognition may comprise using at least one model, in particular a trained model comprising at least one face recognition model. The analyzing of the flood image may be performed by using a face recognition system, such as FaceNet, e.g. as described in Florian Schroff, Dmitry Kalenichenko, James Philbin, “FaceNet: A Unified Embedding for Face Recognition and Clustering”, arXiv: 1503.03832. The trained model may comprises at least one convolutional neural network. For example, the convolutional neural network may be designed as described in M. D. Zeiler and R. Fergus, “Visualizing and understanding convolutional networks”, CoRR, abs/1311.2901, 2013, or C. Szegedy et al., “Going deeper with convolutions”, CORR, abs/1409.4842, 2014. For more details with respect to convolutional neural network for the face recognition system reference is made to Florian Schroff, Dmitry Kalenichenko, James Philbin, “FaceNet: A Unified Embedding for Face Recognition and Clustering”, arXiv: 1503.03832. As training data labelled image data from an image database may be used. Specifically, labeled faces may be used from one or more of G. B. Huang, M. Ramesh, T. Berg, and E. Learned-Miller, “Labeled faces in the wild: A database for studying face recognition in unconstrained environments”, Technical Report 07-49, University of Massachusetts, Amherst, October 2007, the Youtube® Faces Database as described in L. Wolf, T. Hassner, and I. Maoz, “Face recognition in unconstrained videos with matched background similarity”, in IEEE Conf. on CVPR, 2011, or Google® Facial Expression Comparison dataset. The training of the convolutional neural network may be performed as described in Florian Schroff, Dmitry Kalenichenko, James Philbin, “FaceNet: A Unified Embedding for Face Recognition and Clustering”, arXiv: 1503.03832.

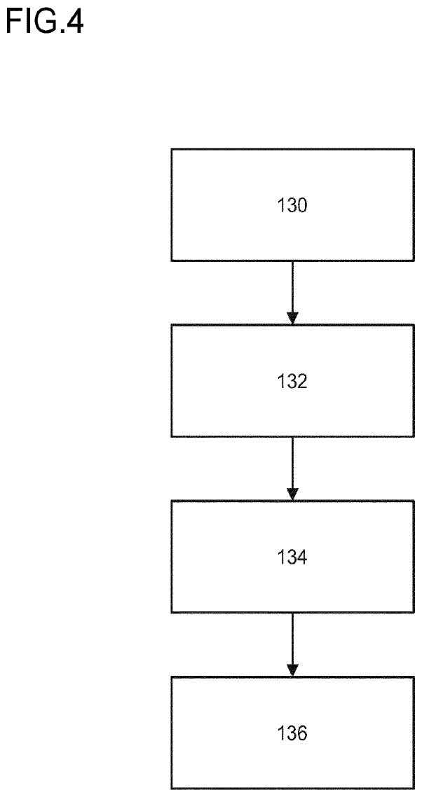

FIG. 4 shows a flow chart of an exemplary embodiment of a method for authenticating a user of a device, in particular of device 110 as described with respect to FIGS. 1 to 4B. The method steps may be performed in the given order or may be performed in a different order. Further, one or more additional method steps may be present which are not listed. Further, one, more than one or even all of the method steps may be performed repeatedly.

The method comprising:
a. projecting (130) a plurality of light beams through the display 114 onto the user by the projector 112, wherein the plurality of light beams comprises a first light beam and a second light beam, and directing the first light beam and the second light beam to illuminate an at least partially overlapping area of the user by the display 114,
b. generating (132) a pattern image showing the projecting of the plurality of light beams onto the user,
c. extracting (134) liveness data from the pattern image,
d. allowing (136) the user to perform an operation on the device that requires authentication based on the liveness data.

The method may be computer-implemented.

The liveness data may be data allowing for distinguishing between a living human, in particular a user, and a non-living object such as a paper, 3D facial masks and the like. The liveness data may comprise blood perfusion data and/or material data. Extracting liveness data may comprises extracting material data and/or extracting blood perfusion data. The liveness data may comprise information about a material of the surface of the user on which the spots are projected. The liveness data may comprise information about at least one vital sign.

The method, e.g. by using the authentication unit, may comprise extracting the material data from the pattern image by beam profile analysis of the light spots. With respect to beam profile analysis reference is made to WO 2018/091649 A1, WO 2018/091638 A1 and WO 2018/091640 A1, the full content of which is included by reference. Extracting material data from the pattern image may comprise generating the material type and/or data derived from the material type. Preferably, extracting material data may be based on the pattern image. Material data may be extracted by using at least one model. Extracting material data may comprise providing the pattern image to a model and/or receiving material data from the model.

The authentication process may be validated based on the extracted material data. In an embodiment, the validating based on the extracted material data may comprise determining if the extracted material data corresponds a desired material data. Determining if extracted material data matches the desired material data may be referred to as validating. Allowing or declining the user and/or object to perform at least one operation on the device that requires authentication based on the material data may comprise validating the authentication or authentication process. Validating may be based on material data and/or image. Determining if the extracted material data corresponds a desired material data may comprise determining a similarity of the extracted material data and the desired material data. Determining a similarity of the extracted material data and the desired material data may comprise comparing the extracted material data with the desired material data. Desired material data may refer to predetermined material data. In an example, desired material data may be skin. It may be determined if material data may correspond to the desired material data. In the example, material data may be non-skin material or silicon. Determining if material data corresponds to a desired material data may comprise comparing material data with desired material data. A comparison of material data with desired material data may result in a allowing and/or declining the user and/or object to perform at least one operation that requires authentication. In the example, skin as desired material data may be compared with non-skin material or silicon as material data and the result may be declination since silicon or non-skin material may be different from skin.

Additionally or alternatively of using material data, the method may comprise extracting blood perfusion data. For example, the light beams projected by the projector may be coherent patterned infrared illumination. Extracting blood perfusion data may comprise determining a speckle contrast of the pattern image and determining a blood perfusion measure based on the determined speckle contrast. The blood perfusion measure may depend on the determined speckle contrast. If the speckle contrast changes, the blood perfusion measure derived from the speckle contrast may change accordingly. A blood perfusion measure may be a single number or value that may represent a likelihood that the object is a living subject.

For example, for determining the speckle contrast, the complete pattern image may be used. Alternatively, for determining the speckle contrast, a section of the pattern image may be used. The section of the pattern image, preferably, represents a smaller area of the pattern image than an area of the complete pattern image. The section of the pattern image may be obtained by cropping the pattern image.

In an embodiment, a data-driven model may be used for determining a blood perfusion measure.

The authentication process may be validated based on the blood perfusion measure. In an embodiment, the validating based on the blood perfusion measure may comprise determining if the blood perfusion measure corresponds to blood perfusion measure of a human being. Determining if the blood perfusion measure corresponds a human being may be referred to as validating. Allowing or declining the user and/or object to perform at least one operation on the device that requires authentication based on the blood perfusion measure may comprise validating the authentication or authentication process. Validating may be based on the blood perfusion measure. Determining if the blood perfusion measure corresponds a human being may comprise comparing the blood perfusion measure to at least one pre-defined or pre-determined range of values of blood perfusion measure, e.g. stored in at least one database. In case the extracted blood perfusion measure is at least within tolerances within the re-defined or pre-determined range of values of blood perfusion measure, the authentication is validated, otherwise not. In case the authentication is validated the method may comprise allowing the user to perform at least one operation that requires authentication. Otherwise, in case the authentication is not validated the method may comprise declining the user to perform at least one operation that requires authentication.

The method comprises allowing 136 the user to perform an operation on the device 110 that requires authentication based on the liveness data, e.g. by using at least one authorization unit. In particular, the method may comprise at least authorization step, e.g. by using at least one authorization unit. The authorization unit may be configured for access control. The authorization unit may comprise at least one processor or may be designed as software or application. The authorization unit and the authentication unit may be embodied integral, e.g. by using the same processor. The authorization unit may be configured for allowing the user to perform at least one operation on the device, e.g. unlocking the device 110, in case of successful authentication of the user or declining the user to perform at least one operation on the device 110 in case of non-successful authentication. Thereby, the user may become aware of the result of the authentication. The method may comprise displaying the result of the authentication on the display 114.

At least one operation on the device that requires authentication may be access to the device, e.g. unlocking the device 110, and/or access to an application, preferably associated with the device 110 and/or access to a part of an application, preferably associated with the device110. In an embodiment, allowing the user to access a resource may include allowing the user to perform at least one operation with a device and/or system. The resource may be a device, a system, a function of a device, a function of a system and/or an entity. Additionally and/or alternatively, allowing the user to access a resource may include allowing the user to access an entity. The entity may be a physical entity and/or a virtual entity. The virtual entity may be a database for example. The physical entity may be an area with restricted access. The area with restricted access may be one of the following: security areas, rooms, apartments, vehicles, parts of the before mentioned examples, or the like. Device and/or system may be locked. The device and/or the system may only be unlocked by an authorized user.

### LIST OF REFERENCE NUMBERS

110 device
112 projector
114 display
116 image generation unit
118 processor
120 flood illumination source
130 projecting
132 generating
134 extracting
136 allowing

1. A method for authenticating a user of a device, the method comprising:
a. projecting a plurality of light beams through a display onto the user by a projector, wherein the plurality of light beams comprises a first light beam and a second light beam, and directing the first light beam and the second light beam to illuminate an at least partially overlapping area of the user by the display,
b. generating a pattern image showing the projecting of the plurality of light beams onto the user,
c. extracting liveness data from the pattern image, and
d. allowing the user to perform an operation on the device that requires authentication based on the liveness data.

2. The method according to claim 1, wherein step a. comprises projecting a light pattern comprising a plurality of light spots, wherein the pattern image generated in step b. is generated by an image generation unit while projecting with the light pattern.

3. The method according to claim 1, wherein emission angles of the projector are selected considering diffraction characteristics of the display.

4. The method according to claim 3, wherein the emission angles of the projector are selected such that light beams corresponding to minor diffraction orders from the display coincide to other minor or zero orders, wherein the minor diffraction orders comprise diffraction orders unequal zero, wherein the minor diffraction orders are diffractions of the order ±1, ±2, or ±3.

5. The method according to claim 3, wherein the emission angles of the projector are selected in accordance to a following rule
$$k \cdot n \frac{λ}{d} = sin ( {θ}_{p r o j , n} )$$
wherein n is an integer, k is a natural number, λ is a wavelength and d is a pixel to pixel distance in one dimension of the display, wherein θ_{proj,n} is the emission angle of the projector.

6. The method according to claim 3, wherein the emission angles of the projector are selected considering tolerances of <50%.

7. The method according to claim 1, wherein the projector comprises at least one least one emitter selected from the group consisting of at least one laser source, at least one semi-conductor laser, at least one double heterostructure laser, at least one external cavity laser, at least one separate confinement heterostructure laser, at least one quantum cascade laser, at least one distributed Bragg reflector laser, at least one polariton laser, at least one hybrid silicon laser, at least one extended cavity diode laser, at least one quantum dot laser, at least one volume Bragg grating laser, at least one Indium Arsenide laser, at least one Gallium Arsenide laser, at least one transistor laser, at least one diode pumped laser, at least one distributed feedback lasers, at least one quantum well laser, at least one interband cascade laser, at least one semiconductor ring laser, at least one vertical cavity surface emitting laser, at least one non-laser light source, at least one LED, at least one light bulb, and at least one edge-emitting laser.

8. The method according to claim 1, wherein the display is configured for modifying light spots generated by the projector when traversing the display, and/or wherein the projector comprises at least one optical element selected from the group consisting of at least one lens, at least one Micro-lens-array, at least one diffractive optical element, and at least one meta surface element.

9. The method according to claim 1, wherein the display is at least partially transparent in at least one continuous area covering the projector and/or an image generation unit, wherein the display has a transmission characteristic of 10%.

10. The method according to claim 1, wherein a number of light beams projected on the user is lower than 5000.

11. The method according to claim 1, wherein the projector projects at least one infrared light pattern, wherein the projected light beams have a wavelength in an infrared spectral range.

12. A device for authenticating a user, the device comprising:
at least one projector configured for projecting the plurality of light beams through at least one display onto the user, wherein the plurality of light beams comprises a first light beam and a second light beam, and directing the first light beam and the second light beam to illuminate an at least partially overlapping area of the user by the display,
at least one image generation unit configured for generating a pattern image showing the projecting of the plurality of light beams onto the user, and
at least one processor configured for extracting liveness data from the pattern image and allowing the user to perform an operation on the device that requires authentication based on the liveness data.

13. A computer program comprising instructions, wherein when the program is executed by the device according to claim 12, the instructions cause the device to perform a method comprising:
a. projecting a plurality of light beams through a display onto the user by a projector, wherein the plurality of light beams comprises a first light beam and a second light beam, and directing the first light beam and the second light beam to illuminate an at least partially overlapping area of the user by the display,
b. generating a pattern image showing the projecting of the plurality of light beams onto the user,
c. extracting liveness data from the pattern image, and
d. allowing the user to perform an operation on the device that requires authentication based on the liveness data.

14. A computer-readable storage medium comprising instructions, wherein when the instructions are executed by the device according to claim 12, the instructions cause the device to perform a method comprising:
a. projecting a plurality of light beams through a display onto the user by a projector, wherein the plurality of light beams comprises a first light beam and a second light beam, and directing the first light beam and the second light beam to illuminate an at least partially overlapping area of the user by the display,
b. generating a pattern image showing the projecting of the plurality of light beams onto the user,
c. extracting liveness data from the pattern image, and
d. allowing the user to perform an operation on the device that requires authentication based on the liveness data.

15. A non-transient computer-readable medium including instructions, wherein when executed by one or more processors, the instructions cause the one or more processors to perform the method according to claim 1.

16. The method according to claim 1, wherein the display is at least partially transparent in at least one continuous area covering the projector and/or an image generation unit, wherein the display has a transmission characteristic below 8%.

17. The method according to claim 1, wherein a number of light beams projected on the user is lower than 3000.

18. The method according to claim 1, wherein the projector projects at least one infrared light pattern, wherein the projected light beams have a wavelength in an infrared spectral range from 800 nm to 1300 nm.

19. The method according to claim 1, wherein the display is at least partially transparent in at least one continuous area covering the projector and/or an image generation unit, wherein the display has a transmission characteristic below 6%.

20. The method according to claim 3, wherein the emission angles of the projector are selected considering tolerances of <40%.
